(19) United States
(12) Patent Application Publication
(10) Pub. No.: US 2020/0242671 A1
(43) Pub. Date: Jul. 30, 2020

(54) SYSTEM AND METHOD FOR PRODUCT ATTRIBUTION EXTRACTION AND UPDATING

(71) Applicant: Walmart Apollo, LLC, Bentonville, AR (US)

(72) Inventors: Phanindra Vuppalapati, SAN JOSE, CA (US); Lara Ganesan, Fremont, CA (US); Rohit Deep, Union City, CA (US)

(21) Appl. No.: 16/262,452

(22) Filed: Jan. 30, 2019

(51) Int. Cl. G06Q 30/06; G06F 16/23

(52) U.S. Cl. CPC G06Q 30/0603; G06F 16/2365

(57) ABSTRACT

Systems and methods for updating product content in an online marketplace utilizing image attributes to improve online searching for products is disclosed. An image is received and associated with a product. Attribute data is extracted from the product image and correlated to product attribute data in a database having a plurality of attribute data associated with a plurality of products. The plurality of products represent items available in an online marketplace. At least one value representing the accuracy of the extracted attribution data is determined against the correlated attribution data. Product attribute data is updated in a database associated with the respective correlated online marketplace product.

### TECHNICAL FIELD

This application relates generally to updating product attributes in an online marketplace. More specifically, the present disclosure is directed to systems and methods for providing an ability to crowdsource updating product content in an online marketplace utilizing image attributes to improve and accurately search for products, maintain statistical information concerning the accuracy of online marketplace product attributes, and enhance the consumer experience.

### BACKGROUND

Accurately identifying items or products in an online marketplace or e-commerce website has been a persistent concern for retailers. Online marketplaces or e-commerce websites traditionally employ a wide variety of search methods to identify items or products available for purchase. Accurately searching for items or products using these search methods is particularly challenging because algorithms or models utilized to match search parameters against known attributes of a product are often inaccurate due to the wide variety of packaging variations across manufacturers. For example, traditional models for searching items or products are in some cases up to 30% inaccurate in identifying the correct product based on product attributes.

In most instances, manufacturers provide packaging attribute information to retailers for items or products. This information may be incorrect which significantly impacts the accuracy of identifying the correct item or product in an online marketplace. In some instances, product packaging information is limited in scope or not provided at all. When this occurs, the ability to search for an item using product packaging attributes is significantly degraded.

There remains a persistent need to dramatically improve the accuracy in identifying items or products in an online marketplace using product packaging attribute information. Furthermore, the solution should be scalable to accommodate large scale retailers who sell a wide variety of items or products in an online marketplace. A comprehensive system is necessary to facilitate updating product attribution data for improving the quality and customer experience in an online marketplace or e-commerce website. Finally, in order to effectively improve search accuracy on a large scale, a system is needed which incorporates crowdsourcing functionality and generates statistical accuracy information.

### SUMMARY

In various embodiments, a system including a computing device is disclosed. The computing device is configured to receive an image associated with a product. The computing device is further configured to extract attribution data associated with the product from the image and correlate the extracted attribution data to product attribute data in a database having a plurality of attribution data associated with a plurality of products. The plurality of products represent items available in an online marketplace. The computing device determines at least one value representing the accuracy of the extracted attribution data against the correlated attribution data and updates product attribution data in the database associated with the respective correlated online marketplace product.

In various embodiments, a non-transitory computer readable medium having instructions stored thereon is disclosed. The instructions, when executed by a processor cause a device to perform operations including receiving an image associated with a product and extracting attribution data associated with the product from the image. The instructions further cause the device correlate attribution data associated with the product to a database having a plurality of attribution data associated with a plurality of products. The plurality of products represent items available in an online marketplace. The instructions cause the device to determine at least one value representing the accuracy of the extracted attribution data against the correlated attribution data and improve the accuracy of a search for an item in an online marketplace based on the at least one value representing accuracy of the extracted attribution data against the correlated attribution data.

In various embodiments, a method is disclosed. The method includes a step receiving an image associated with a product and extracting attribution data associated with the product from the image. Attribution data associated with the product is correlated to a database having a plurality of attribution data associated with a plurality of products. The plurality of products represent items available in an online marketplace. At least one value is determined representing the accuracy of the extracted attribution data against the correlated attribution data. The accuracy of a search for a product in an online market place is improved based on the at least one value representing accuracy of the extracted attribution data against the correlated attribution data.

### BRIEF DESCRIPTION OF THE DRAWINGS

The features and advantages will be more fully disclosed in, or rendered obvious by the following detailed description of the preferred embodiments, which are to be considered together with the accompanying drawings wherein like numbers refer to like parts and further wherein:

FIG. 1A illustrates one example of a system in accordance with some embodiments of the present disclosure.

FIG. 1B illustrates one example of an architecture of a mobile device in accordance with some embodiments of the present disclosure.

FIG. 2 is a diagram of system management server components in accordance with some embodiments of the present disclosure.

FIG. 3 is a flowchart illustrating an example of updating product attribution data in accordance with some embodiments of the present disclosure.

FIGS. 4A-4C are example user interfaces for creating a user profile in accordance with some embodiments of the present disclosure.

FIGS. 5A-5E are example user interfaces for updating product attribution data in accordance with some embodiments of the present disclosure.

FIGS. 6A-6B are example user interfaces for crowdsourcing and feedback in accordance with some embodiments of the present disclosure.

### DETAILED DESCRIPTION

The description of the exemplary embodiments is intended to be read in connection with the accompanying drawings, which are to be considered part of the entire written description. The use of the singular includes the plural unless specifically stated otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting.

As used herein, use of a singular article such as “a,” “an” and “the” is not intended to exclude pluralities of the article's object unless the context clearly and unambiguously dictates otherwise.

The embodiments described herein provide systems and methods in which attribution data is extracted from an image of a product and stored or updated in database for improving relational search accuracy on an online marketplace. The embodiments described herein, include for example, determining at least one value representing the accuracy of attribution data extracted from an image against attribution data stored in a database. In various embodiments, the at least one value may be used to improve the accuracy of a relational product search in an online marketplace. The embodiments further include generating and maintaining statistical information for improving the accuracy of search models. In some embodiments, statistical information is associated with a user profile to facilitate updating or generating product attribution data via crowdsourcing. Additional embodiments include communication and verification systems and methods for updating and generating product attribution data between third party manufacturers and retailers facilitating an online marketplace.

Although the embodiments described herein illustrate product attribution extraction and updating systems and methods used for improving relational identification and search on e-commerce websites and online marketplaces, the embodiments discussed herein are not limited to such systems and methods, and one of ordinary skill in the art will appreciate that the current disclosure may be used in connection with any type of system or method that addresses various different types of information exchange and verification problems.

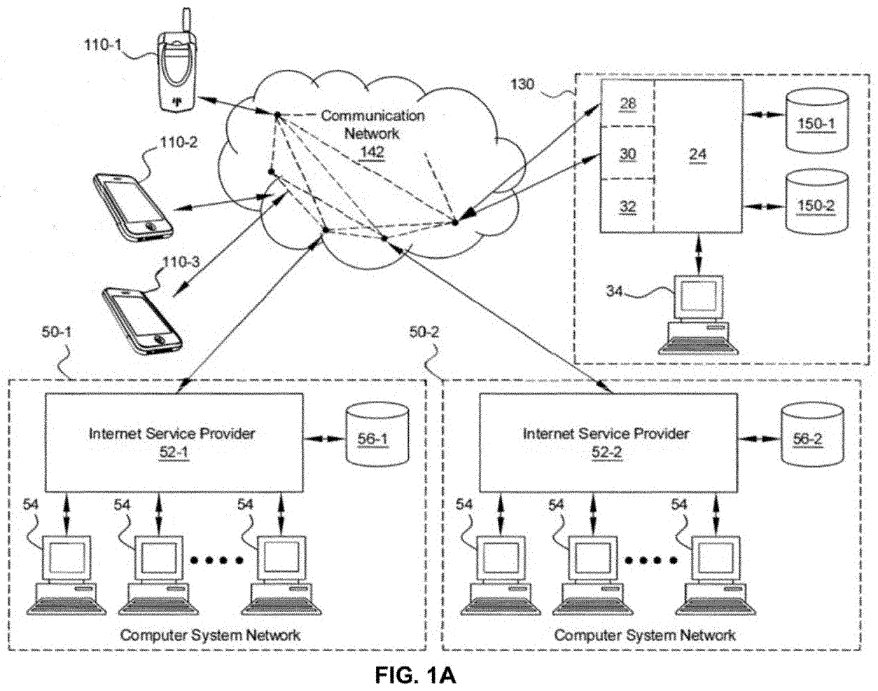

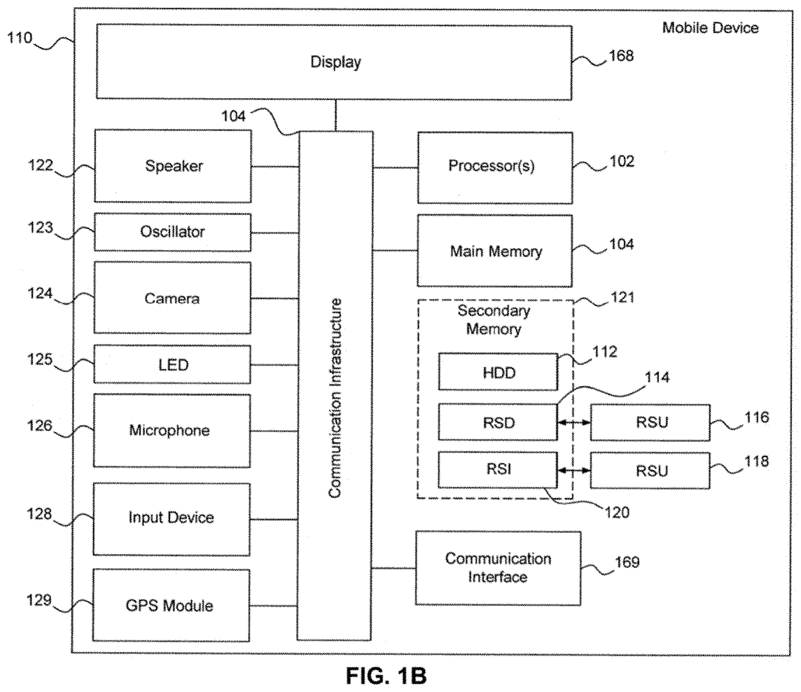

FIG. 1A depicts an example of a system 100 in which a plurality of client devices 110-1, 110-2, and 110-3 (collectively “client devices 110”) are connected via communication network 142 to one or more computer system networks 50-1, 50-2 (“communication networks 50”), and to a management server 130. Communication network 142 may be a wide area network (“WAN”), a local area network (“LAN”), a personal area network (“PAN”), or the like. In one embodiment, communication network 142 is the Internet and client devices 110 are online. “Online” may mean connecting to or accessing source data or information from a location remote from other devices or networks coupled to communication network 142.

Management server 130 includes a processing unit 24 coupled to one or more data storage units 150-1, 150-2 (collectively referred to as “database management system 150” or “DBMS 150”). The processing unit 24, in some embodiments is configured to provide front-end graphical user interfaces (“GUI”) (e.g., client GUI and vendor GUI), and a back-end or administrative graphical user interface or portal to one or more remote computers 54 or to one or more local computers 34. In some embodiments, a client interface (not shown) is provided that accesses management server 130 via a GUI. The GUIs can take the form of, for example, a webpage that is displayed using a browser program local to remote computers 54 or to one or more local computers 34. It is understood that the system 100 may be implemented on one or more computers, servers, or other computing devices. In some embodiments, the GUI may be displayed on client devices 110 via a software application. For example, system 100 may include additional servers programmed or partitioned based on permitted access to data stored in DBMS 150. As used herein, “portal” is not limited to general-purpose Internet portals, such as YAHOO! (“YAHOO!” is a registered trademark of Oath Holdings Inc. of Sunnyvale, Calif.) or GOOGLE (“GOOGLE” and the Google Logo are registered trademarks of Google LLC of Mountain View, Calif.), but also includes GUIs that are of interest to specific, limited audiences and that provide the party access to a plurality of different kinds of related or unrelated information, links, apps and tools as described below. “Webpage” and “website” may be used interchangeably herein.

Remote computers 54 may be part of a computer system network 50-1, 50-2 and gain access to communication network 142 through an Internet service provider (“ISP”) 52-1, 52-2 (“ISPs 52”). Client devices 110 may gain access to communications network 142 through a wireless cellular communication network, a WAN hotspot, or through a wired or wireless connection with a computer as will be understood by one skilled in the art. Clients and vendors, as described below, may use remote computers 54 and/or client devices 110 to gain access to system 100.

In one embodiment, client devices 110 includes any mobile device capable of transmitting and receiving wireless signals. Examples of mobile instruments include, but are not limited to, mobile or cellular phones, personal digital assistants (“PDAs”), laptop computers, tablet computers, music players, and e-readers, to name a few possible devices.

In various embodiments, as described in further detail below, client devices 110 are configured to display dynamic forms or GUIs as part of receiving an image, creating a profile, identifying products or items that need updated attributes, or facilitating competition tasks during crowdsourcing. In some embodiments, management server 130 of system 100 is configured to receive product attribution data associated with an image and generate plurality of dynamic forms that may be associated with the respective product. In various embodiments, the dynamic forms may self-populate based on correlated attribution data from the image. Alternatively, GUIs may provide for manual input of information into the forms. In some embodiments, management server 130 of system 100 is configured to receive scan of a visual identifier (e.g., a barcode, reference identification, QR code and/or a visual identifier) associated with a product for inputting information in the dynamic forms of the GUI. As will be explained in detail below, if the scanned item was not found, a user associated with client device 110 may still submit product information for the item associated with the received product attribution data. In embodiments, scanning an item is treated as an alert or notification to a category specialists to identify the product and generate or update metrics associated with the product.

FIG. 1B is a block diagram of one example of an architecture of client device 110. As shown in FIG. 1B, client device 110 includes one or more processors, such as processor(s) 102. Processor(s) 102 may be any central processing unit (“CPU”), microprocessor, micro-controller, or computational device or circuit for executing instructions. Processor(s) are connected to a communication infrastructure 104 (e.g., a communications bus, cross-over bar, or network). Various software embodiments are described in terms of this exemplary mobile device 110. After reading this description, it will be apparent to one of ordinary skill in the art how to implement the method using client devices 110 that include other systems or architectures. One of ordinary skill in the art will understand that computers 34 and 54 may have a similar and/or identical architecture as that of client devices 110. Put another way, computers 34 and 54 can include some, all, or additional functional components as those of the client device 110 illustrated in FIG. 1B.

Client device 110 includes a display 168 that displays graphics, video, text, and other data received from the communication infrastructure 104 (or from a frame buffer not shown) to a user (e.g., a subscriber, commercial user, back-end user, or other user). Examples of such displays 168 include, but are not limited to, LCD screens, OLED display, capacitive touch screen, and a plasma display, to list only a few possible displays. Client device 110 also includes a main memory 108, such as a random access (“RAM”) memory, and may also include a secondary memory 110. Secondary memory 110 may include a more persistent memory such as, for example, a hard disk drive (“HDD”) 112 and/or removable storage drive (“RSD”) 114, representing a magnetic tape drive, an optical disk drive, solid state drive (“SSD”), or the like. In some embodiments, removable storage drive 114 reads from and/or writes to a removable storage unit (“RSU”) 116 in a manner that is understood by one of ordinary skill in the art. Removable storage unit 116 represents a magnetic tape, optical disk, or the like, which may be read by and written to by removable storage drive 114. As will be understood by one of ordinary skill in the art, the removable storage unit 116 may include a tangible and non-transient machine readable storage medium having stored therein computer software and/or data.

In some embodiments, secondary memory 110 may include other devices for allowing computer programs or other instructions to be loaded into client device 110. Such devices may include, for example, a removable storage unit (“RSU”) 118 and a corresponding interface (“RSI”) 120. Examples of such units 118 and interfaces 120 may include a removable memory chip (such as an erasable programmable read only memory (“EPROM”)), programmable read only memory (“PROM”)), secure digital (“SD”) card and associated socket, and other removable storage units 118 and interfaces 120, which allow software and data to be transferred from the removable storage unit 118 to client device 110.

Client device 110 may also include a speaker 122, an oscillator 123, a camera 124, a light emitting diode (“LED”) 125, a microphone 126, an input device 128, and a global positioning system (“GPS”) module 129. Examples of input device 128 include, but are not limited to, a keyboard, buttons, a trackball, or any other interface or device through a user may input data. In some embodiment, input device 128 and display 168 are integrated into the same device. For example, display 168 and input device 128 may be touchscreen through which a user uses a finger, pen, and/or stylus to input data into client device 110.

Client device 110 also includes one or more communication interfaces 169, which allows software and data to be transferred between client device 110 and external devices such as, for example, another client device 110, a computer 34, 54 and other devices that may be locally or remotely connected to mobile device 100. Examples of the one or more communication interfaces 169 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 169 may also include a wireless interface configured for short-range communication, such as near field communication (“NFC”), Bluetooth, or other interface for communication via another wireless communication protocol. As briefly noted above, one of ordinary skill in the art will understand that computers 34, 54 and portions of system 100 may include some or all components of client device 110.

Software and data transferred via the one or more communications interfaces 169 are in the form of signals, which may be electronic, electromagnetic, optical, or other signals capable of being received by communications interfaces 169. These signals are provided to communications interface 169 via a communications path or channel. The channel may be implemented using wire or cable, fiber optics, a telephone line, a cellular link, a radio frequency (“RF”) link, or other communication channels.

In this document, the terms “non-transitory computer program medium” and “non-transitory computer readable medium” refer to media such as removable storage units 116, 118, or a hard disk installed in hard disk drive 112. These computer program products provide software to client device 110. Computer programs (also referred to as “computer control logic”) may be stored in main memory 108 and/or secondary memory 110. Computer programs may also be received via the one or more communications interfaces 169. Such computer programs, when executed by a processor(s) 102, enable the client device 110 to perform the features of the method discussed herein.

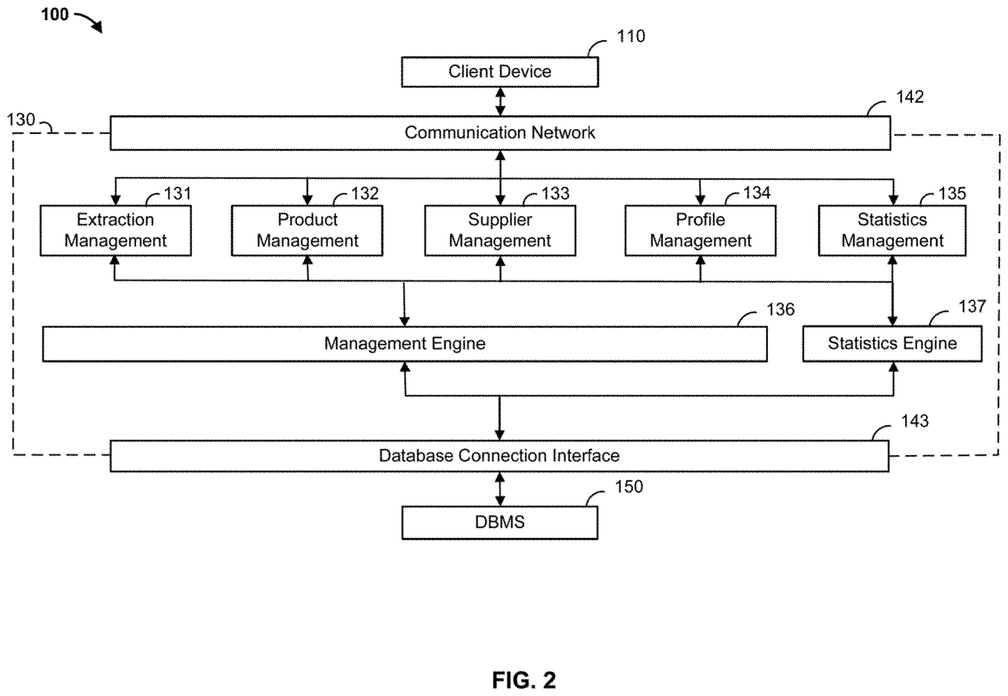

FIG. 2 is a diagram of system 100 management server 130 components in accordance with some embodiments of the present disclosure. In various embodiments, system 100 may be a computing environment including one or more client devices 110, management server 130, one or more software management modules 131, 132, 133, 134, and 135 one or more software engines 136 and 137, database connection interface 143, database management system 150, and a communication network 142 connecting various components of system 100. Although one client device 110 is shown in FIG. 2, any number of client devices may be present. In various embodiments, client device 110 is a user device capable of connecting to the Internet or similar network as will be described below. In some embodiments, at least one client device is a user conducting a transaction on system 100. In various embodiments, as will be described in further detail below, at least one computer network 50 is a third party vendor that fulfills the transaction generated on client device 110.

In various embodiments, management server 130 may comprise a rules engine (not shown) in communication with database management system 150 via a database connection interface 143. In some embodiments, the rules engine is executed by a processor, which reads rules stored in database management system 150 and returns processed rules for use by management modules 131, 132, 133, 134, and 135 one or more software engines 136 and 137. For example, as will be discussed in further detail below, the rules engine may be associated with profile management module 134 to perform profile validation and management of dynamic forms associated with a user login or user product attribute extraction. Alternatively, the rules engine may perform database entry validation for product attribution data associated with an online marketplace. As will be discussed in further detail below, for example, extraction management 131 is a module that processes product image extraction requests from client device 110 via communication network 142 for extrapolating and correlating attribute data from an image. In this example, product identification information forms are dynamically generated which retrieve product information via DBMS 150 and returns the dynamically generated form via a GUI to client device 110, as will be discussed in more detail below. It should be appreciated that one or more modules and/or engines that perform the same functions as described herein may be used to achieve the transaction data processes described throughout this disclosure.

In some embodiments, system 100 may comprise a printer (not shown) communicatively coupled to system 100 and/or client device 110. A printer may be any printing device that is used to generate product attribution identification forms or statistical information associated with the system (e.g., crowdsourcing statistics, attribution accuracy information, product identification information) or any other suitable label or marker for identifying characteristics of the product attribute extraction and correlation process as described throughout this specification.

In various embodiments, as shown in FIGS. 1A-B, and 2, client device 110 may include a computing device such as a hashing computer, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), or any other suitable computing device configured to store data and software instructions, execute software instructions to perform operations, and/or display information on a display device. Client device 110 may be associated with one or more users (not shown). For example, a user operates client device 110, causing it to perform one or more operations in accordance with various embodiments.

Client device 110 includes one or more tangible, non-transitory memories that store data and/or software instructions, and one or more processors configured to execute software instructions. Client device 110 may include one or more display devices that display information to a user and one or more input devices (e.g., keypad, keyboard, touchscreen, voice activated control technologies, or any other suitable type of known input device) to allow the user to input information to the client device. Client device 110 processor(s) may be any central processing unit (“CPU”), microprocessor, micro-controller, or computational device or circuit for executing instructions. Processor(s) are connected to a communication infrastructure (e.g., a communications bus, cross-over bar, or network). Various software embodiments are described in terms of this exemplary client device 110. After reading this description, it will be apparent to one of ordinary skill in the art how to implement the method using client device 110 that include other systems or architectures. One of ordinary skill in the art will understand that computers may have a similar and/or identical architecture as that of client device 110. Put another way, computers can include some, all, or additional functional components as those of the client device 110 illustrated in FIGS. 1A-B, and 2.

Embodiments of the subject matter described in this specification can be implemented in a system 100 that includes a back end component, e.g., as a data server, or that includes a middleware component, e.g., an application server, or that includes a front end component (e.g., a client device 110) having a graphical user interface or a Web browser through which a user can interact with an implementation of the subject matter described is this specification, or any combination of one or more such back end, middleware, or front end components. The components of the system can be interconnected by any form or medium of digital data communication, (e.g., a communication network 142). Communications network 142 may include one or more communication networks or media of digital data communication. Examples of communication network 142 include a local area network (“LAN”), a wireless LAN, a RF network, a Near Field Communication (NFC) network, (e.g., a “WiFi” network), a wireless Metropolitan Area Network (MAN) connecting multiple wireless LANs, NFC communication link(s), and a wide area network (“WAN”), e.g., the Internet and combinations thereof. In accordance with various embodiments of the present disclosure, communications network 142 may include the Internet and any publicly accessible network or networks interconnected via one or more communication protocols, including, but not limited to, a Uniform Resource Locator (URL), hypertext transfer protocol (HTTP) and HyperText Transfer Protocol Secured (HTTPS) and Secured Socket Layer/Transport Layer Security (SSL/TLS) and transmission control protocol/internet protocol (TCP/IP). Communications protocols in accordance with various embodiments also include protocols facilitating data transfer using radio frequency identification (RFID) communications and/or NFC. Moreover, communications network 142 may also include one or more mobile device networks, such as a GSM or LTE network or a PCS network, allowing a client device to send and receive data via applicable communications protocols, including those described herein. For ease of illustration, communication network 142 is shown as an extension of management server 130.

A client device 110 and server 130 are generally remote from each other and typically interact through a communication network 142. The relationship of client device 110 and management server 130 arises by virtue of computer programs running on the respective system components and having a client-server relationship to each other. System 100 may include a web/application server (not shown) in embodiments used to gain access to many services provided by management server 130.

According to various embodiments, management server 130 is configured to update or generate product attribution data from an image. For example, attribution data may be associated with a physical characteristic (e.g., brand, color, size, weight, etc.) of a product or item. One of ordinary skill in the art would understand that attribution data may be any information identifiable or extrapolated from an image. In various embodiments, attribution data associated with an image may be utilized to generate or update online marketplace attribute data, communicate attribution data for verification to manufacturers associated with a product, or improve search model/algorithm accuracy for relationally identifying products in an online marketplace or e-commerce search.

As described above, system 100 may comprise remote computers 54 that may be part of a computer system network 50-1, 50-2 and gain access to communication network 142 through an Internet service provider (“ISP”) 52-1, 52-2 (“ISPs 52”). In various embodiments, computer system networks 50-1, 50-2 may represent third party manufacturers. In some embodiments, computer system networks 50-1, 50-2 may represent online marketplace or e-commerce systems for facilitating online transactions. In various embodiments, management server 130 is configured to receive images and extract attribution data from the image associated with a product. For example, a user associated with a profile may transmit an image using client device 110 via management server 130 for extracting attribute data from the image and communicating the attribution data to a third party manufacturer via computer system network 50-1 for verification and authorization to update the attribution data for use in the online marketplace. In this example, attribution data of the product may be related to size, color, weight, etc. In various embodiments, management server 130 is configured to display, retrieve, store, and process attribution data associated with a plurality of products. In some embodiments, management server 130 is configured to generate and/or record statistical/historical information relating to the received image attribution data, accuracy of the extracted attribution data against the correlated attribution data for a respective product, or crowdsourcing information associated with user profiles.

According to various embodiments, management server 130 is configured to generate and maintain profiles on users. In some embodiments, management server 130 is configured to retrieve and maintain personal identity information associated with a respective user. In various embodiments, management server 130 is configured to generate and maintain statistical information associated with a user profile. For example, a user may generate and transmit an image to management server 130 using client device 110 via communication network 142. Using this example, management server 130 is configured to maintain statistical information relating to the user profile associated with the client device 110 when the image is received by management server 130. Further, management server 130 may identify competitions or evaluate and display a plurality of user profiles using statistical information in a ranking or categorical matter as would be understood in the art. Using this example, statistical engine 137 may process a competition wherein statistics management 135 in communication with profile management 134 identifies user profiles and ranks or organizes the user profiles based on the number of images received by management server 130, accuracy of the attribution data, and/or completion of a pre-defined task list of products requesting updated attribution data. In this way, management server 130 is configured to crowdsource updating product attribution data utilizing a competition.

In various embodiments, system 100 is configured to receive an image and extract attribute data from the image for updating attribute data associated with an online marketplace. In some embodiments, as shown in FIG. 2, management server 130 is configured maintain a plurality of product attribute data. For example, management server 130 may maintain a plurality of product attribute data and process product attribution data received or transmitted in the system utilizing product management 132. In this example, product management 132 may correlate extracted attribution data from an image via extraction management 131. Alternatively, product management module 132 may facilitate communicating correlated attribution data with an online marketplace or e-commerce website. In this example, management server 130 may be configured to update attribution data associated with a product in system 100 via computer system network 50-1 or 50-2. It would be appreciated by one of ordinary skill in the art that system 100 may utilize a variety of means for updating attribution data in storage device for use in an online marketplace.

According to some embodiments, management server 130 is configured to communicate with third party manufacturers via communication network 142. In this example, management server 130 may use supplier management 133 to communicate extracted attribution data to respective manufacturers of products associated with extracted attribute data. In this example, supplier management 133 facilitates validation, authorization, and updating of manufacturer attribution data. Furthermore, a manufacturer of a respective product in an online marketplace may deny updating attribute data for a product based on the extracted attribute data. In this instance, management server 130 via supplier management 133 is configured to deny updating product attribution information in the database for the online marketplace.

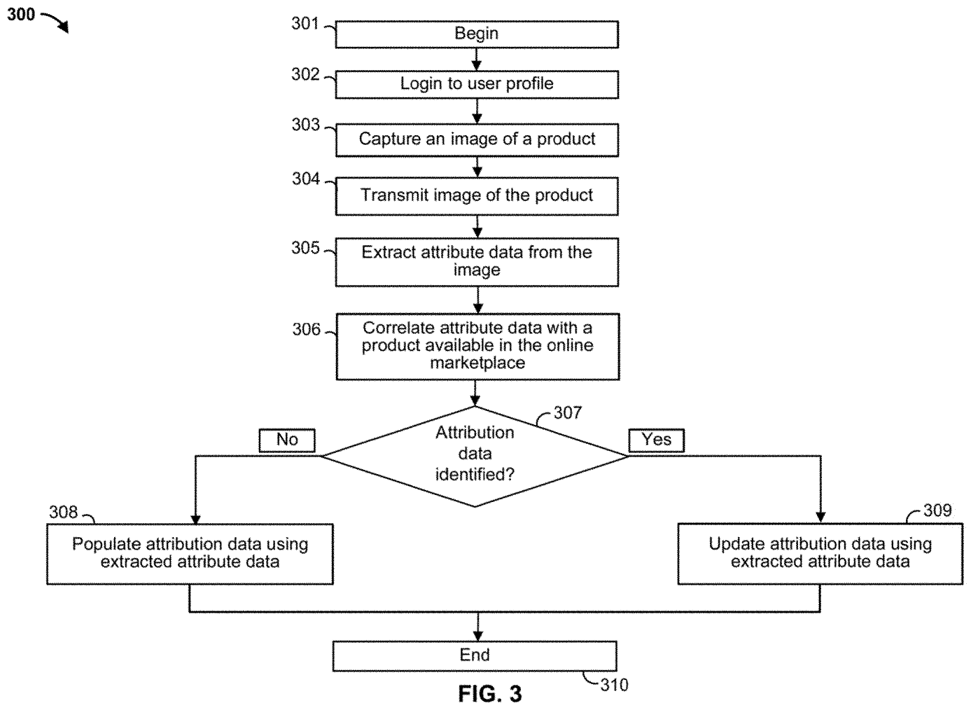

FIG. 3 illustrates an example process 300 of updating product attribution data that may be used with the system shown in FIG. 1A in accordance with some embodiments of the present disclosure. At 301, the updating product attribution process begins. At 302, a user logins into a user profile vie a GUI on client device 110. In some embodiments, credentials are verified to authenticate the login of a user profile. In various embodiments, management server 130 is configured to facilitate authenticating user profile credentials via profile management 134. At 303, user associated with client device 110 captures an image of a product. At 304, management server 130 receives the image. At 305, attribute data is extracted from the image. In some embodiments, management server 130 is configured to extract attribute data from an image via extraction management 131. In various embodiments, extraction management 131 utilizes an extraction engine to identify various attributes from the image. At 306, extracted attribution data is correlated with attribute data associated with a product available in an online marketplace. In various embodiments, management server 130 is configured to correlate attribution data stored in DBMS 150 or computer system network 50-1 and 50-2 with extracted attribution data obtained from an image. At step 307, if attribution data is identified as corresponding to a respective product in an online marketplace, at 309, the attribution data is updated with extracted attribution data from the image. At 308, if attribution data does not correlate to a respective product in an online marketplace, the attribution data is populated for a respective product identified by the user. In this example, dynamic forms may generate for GUIs associated with client device 110 for a user associated with client device 110 to identify the product in the online marketplace. At 310, the updating product attribution process ends.

In some embodiments, dynamic forms may be generated using a Java Script Object Notation (“JSON”) payload. It should be appreciated, that one of ordinary skill in the art will understand that dynamic forms may be generated using various software and/or hardware implementations such as YAML, BSON, MessagePack and the like.

In some embodiments, a plurality of users having respective user profiles may update attribution data for a plurality of products. In this example, crowdsourcing is used to update a plurality of attribute data associated with a plurality of products. In various embodiments, statistical information associated the number of product attributes updated or identified for update may be associated with respective user profiles. In some embodiments, a competition may occur wherein statistical information is utilized to identify a winner.

It should be appreciated to one of ordinary skill in the art that updating attribution data for a specific product improves the relational engine or model utilized to search for products in an online database. Moreover, the accuracy of the engine or model may be improved using statistical data related to the accuracy between extracted attribute data and correlated attribution data for a respective product when extrapolated over a plurality of products in an online marketplace.

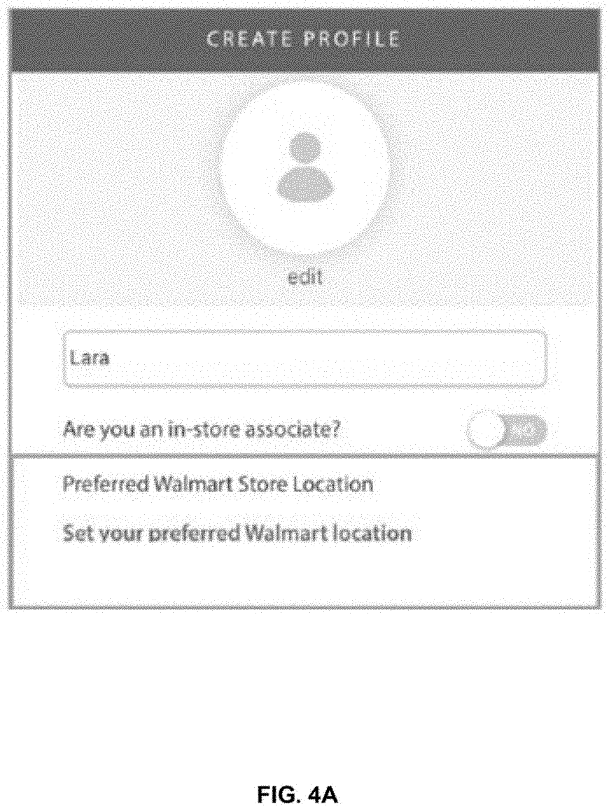

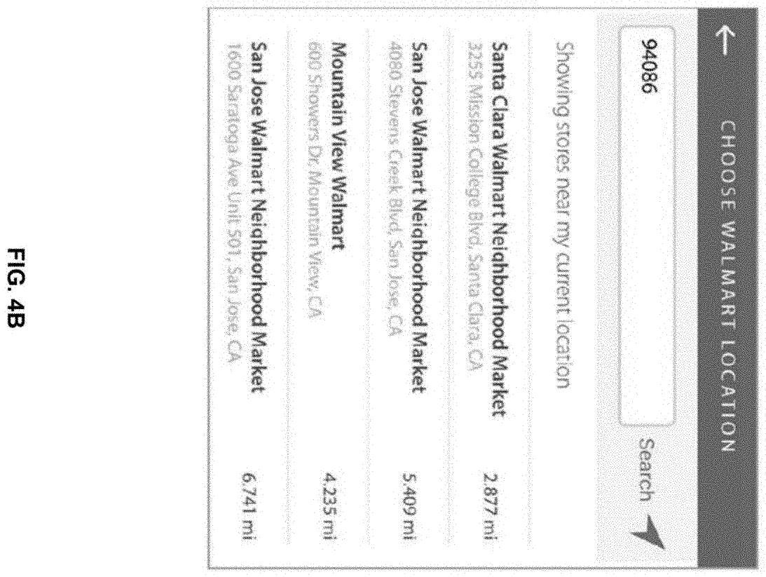

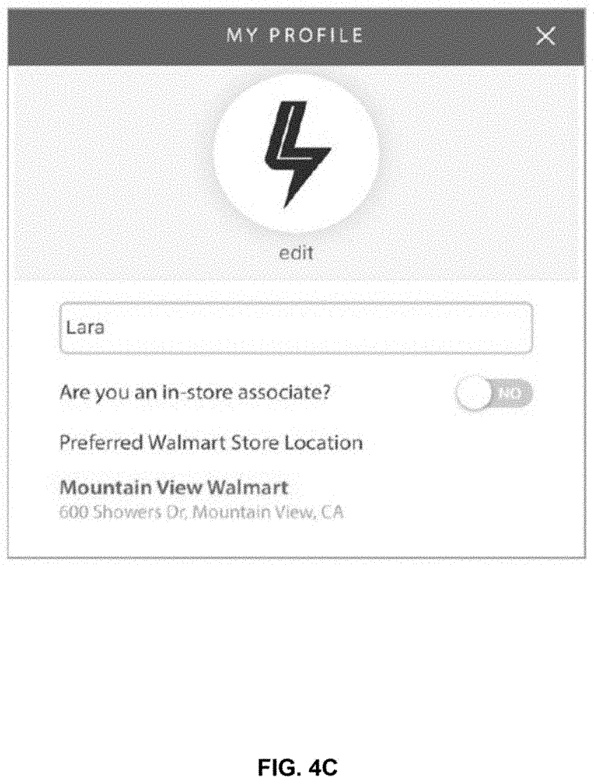

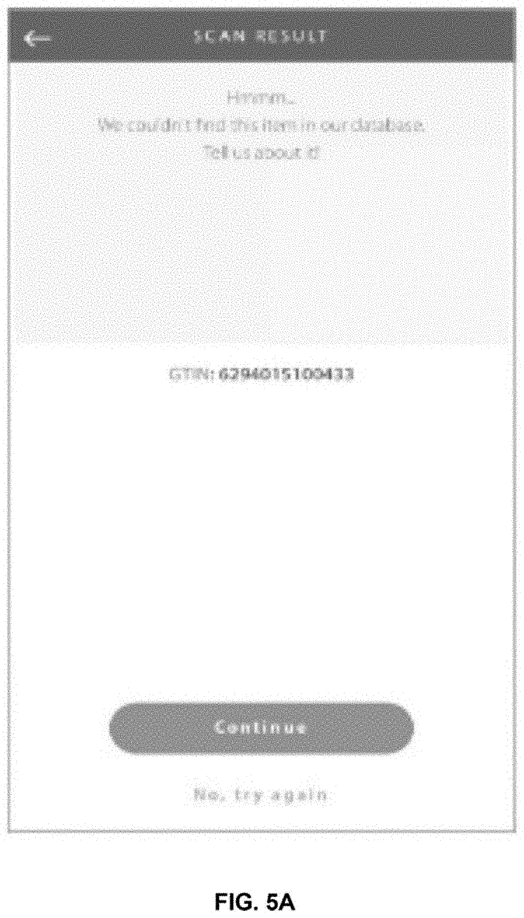

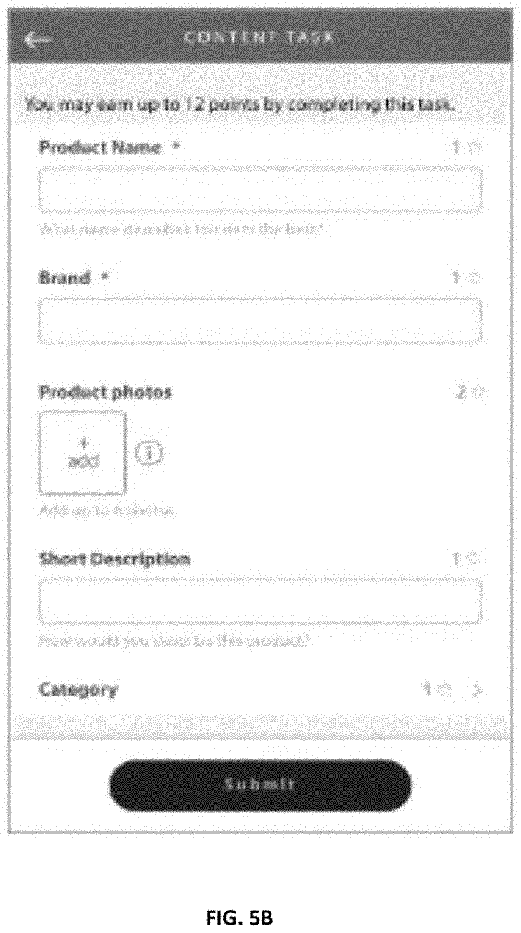

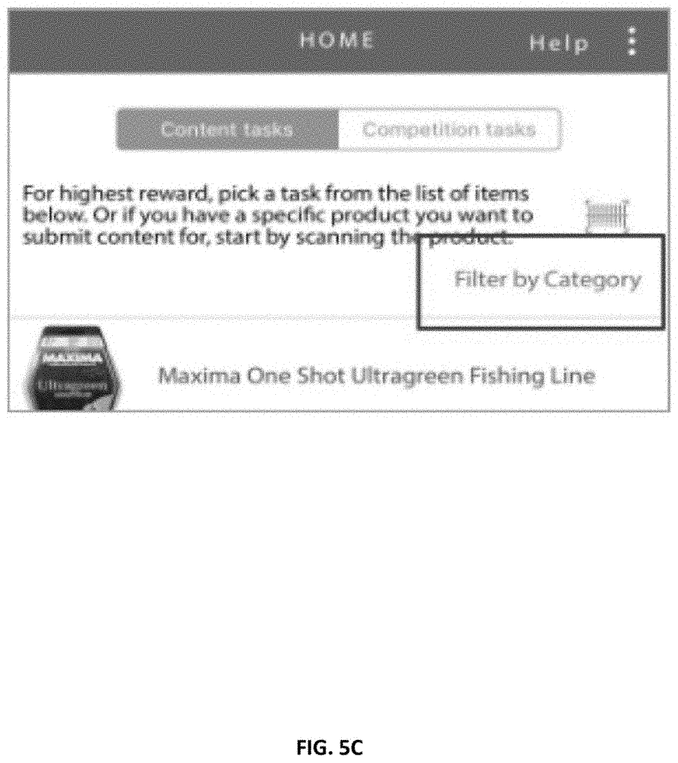

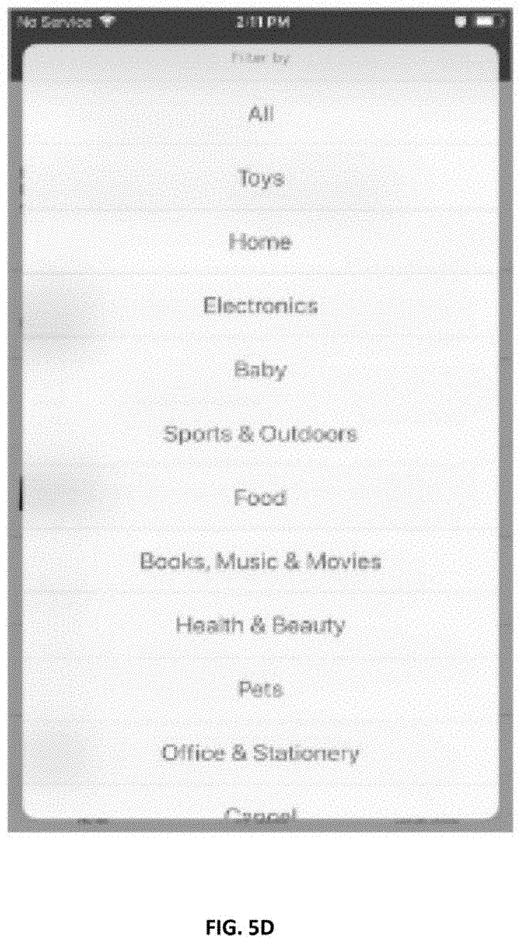

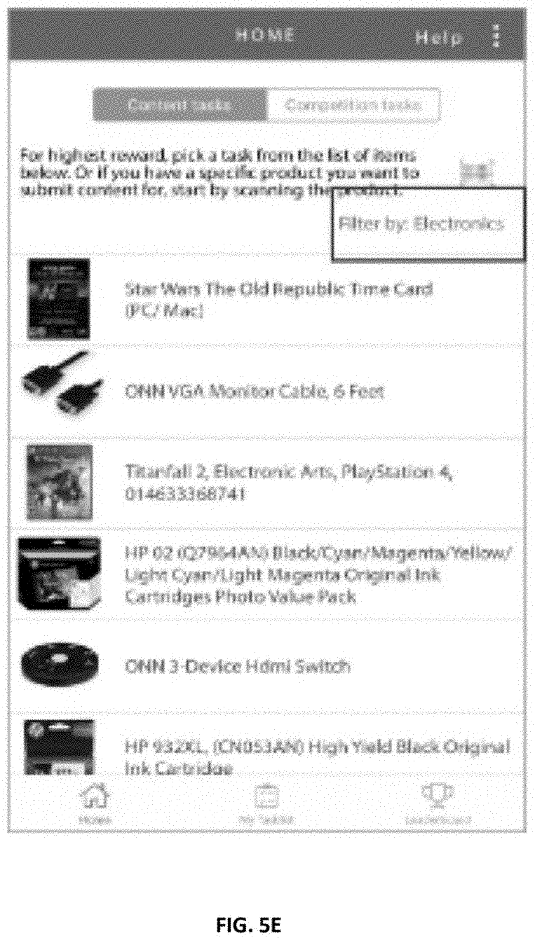

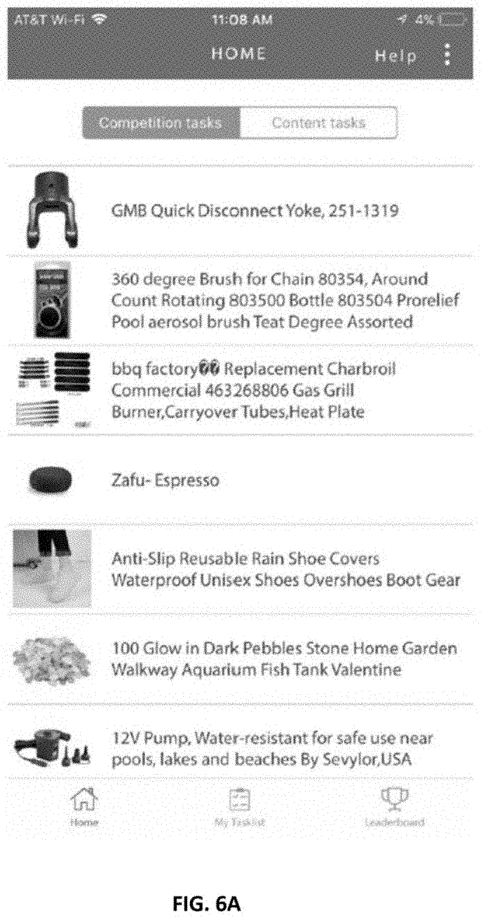

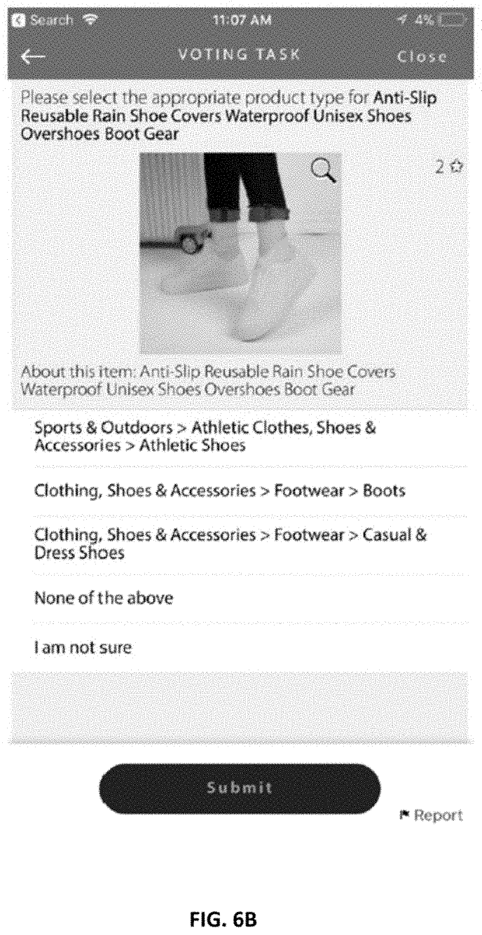

FIGS. 4A-4C are example user interfaces for creating a user profile in accordance with some embodiments of the present disclosure. FIGS. 5A-5E are example user interfaces for updating product attribution data in accordance with some embodiments of the present disclosure. FIGS. 6A-6B are example user interfaces for crowdsourcing and feedback in accordance with some embodiments of the present disclosure.

The various embodiments described herein may employ various computer-implemented operations involving data stored in computer systems. For example, these operations may require physical manipulation of physical quantities usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system. The computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A system, comprising:
a computing device configured to:
receive an image associated with a product;
extract attribution data associated with the product from the image;
correlate the extracted attribution data to product attribution data in a database having a plurality of attribution data associated with a plurality of products, wherein the plurality of products represent items available in an online marketplace;
determine at least one value representing the accuracy of the extracted attribution data against the correlated attribution data; and
update product attribution data in the database associated with the respective correlated online marketplace product.

2. The system of claim 1, wherein the computing device is further configured maintain statistics associated with the accuracy of the extracted attribution data against the correlated attribution data.

3. The system of claim 2, wherein the computing device is further configured to associate a received image with a user profile, wherein statistics associated with the accuracy of the extracted attribution data against the correlated attribution data are associated with a respective user profile for a respective received image.

4. The system of claim 1, wherein attribution data associated with the product includes at least one of weight, brand, size, or color.

5. The system of claim 1, wherein the computing device is further configured to improve the accuracy of a search for an item in an online marketplace based on the at least one value representing accuracy of the extracted attribution data against the correlated attribution data.

6. The system of claim 1, wherein the attribution data is updated on the database having a plurality of attribution data associated with a plurality of products.

7. The system of claim 1, wherein the computing device is further configured to update online market place product information for a respective product based on the updated attribution data.

8. The system of claim 1, wherein the computing device is further configured to communicate extracted attribution data to a product manufacturer associated with respective items correlated and available in the online marketplace.

9. The system of claim 8, wherein the computing device is further configured to update attribution data in the database based on a verification information from the product manufacturer associated with the communicated extracted attribution data.

10. A non-transitory computer readable medium having instructions stored thereon, wherein the instructions, when executed by a processor cause a device to perform operations comprising:
receiving an image associated with a product;
extracting attribution data associated with the product from the image;
correlating attribution data associated with the product to a database having a plurality of attribution data associated with a plurality of products, wherein the plurality of products represent items available in an online marketplace;
determining at least one value representing the accuracy of the extracted attribution data against the correlated attribution data; and
improving the accuracy of a search for an item in an online marketplace based on the at least one value representing accuracy of the extracted attribution data against the correlated attribution data.

11. The non-transitory computer readable medium of claim 11, wherein the instructions, when executed by the processor, cause the device to perform further operations comprising: generating statistical information representing the accuracy of the extracted attribution data against the correlated attribution data.

12. The non-transitory computer readable medium claim 12, wherein the instructions, when executed by the processor, cause the device to perform further operations comprising: associating a received image with a user profile, wherein statistics associated with the accuracy of the extracted attribution data against the correlated attribution data are associated with a respective user profile for a respective received image.

13. The non-transitory computer readable medium of claim 11, wherein the attribution data associated with product includes at least one of weight, brand, size, or color.

14. The non-transitory computer readable medium of claim 14, wherein the instructions, when executed by the processor, cause the device to perform further operations comprising: updating attribution data in the database using the extracted attribution data associated with the respective correlated online marketplace product.

15. The non-transitory computer readable medium of claim 11, wherein the instructions, when executed by the processor, cause the device to perform further operations comprising:
updating online market place product information for a respective product based on the updated attribution data.

16. The non-transitory computer readable medium of claim 16, wherein the instructions, when executed by the processor, cause the device to perform further operations comprising:
communicating extracted attribution data to a product manufacturer associated for respective products correlated and available in the online marketplace.

17. A method, comprising:
receiving an image associated with a product;
extracting attribution data associated with the product from the image;
correlating attribution data associated with the product to a database having a plurality of attribution data associated with a plurality of products, wherein the plurality of products represent items available in an online marketplace;
determining at least one value representing the accuracy of the extracted attribution data against the correlated attribution data; and
improving the accuracy of a search for a product in an online marketplace based on the at least one value representing accuracy of the extracted attribution data against the correlated attribution data.

18. The method of claim 17, comprising:
updating attribution data in the database using the extracted attribution data associated with the product from the image that has been correlated to an item available in an online marketplace.

19. The method of claim 18, comprising:
generating statistical information associated with the accuracy of the extracted attribution data against the correlated attribution data.

20. The method of claim 19, comprising:
associating the received image with a user profile, wherein the generated statistical information is associated with a respective user profile for a respective image.
